(19) United States
(12) Patent Application Publication
(10) Pub. No.: US 2021/0188173 A1
(43) Pub. Date: Jun. 24, 2021

(54) ANTI-GLARE APPARATUS AND METHOD FOR MANUFACTURING THE SAME, REAR-VIEW MIRROR, AND ANTI-GLARE METHOD

(71) Applicants: Fuzhou BOE Optoelectronics Technology Co., Ltd., Fuzhou (CN); BOE TECHNOLOGY GROUP CO., LTD., Beijing (CN)

(72) Inventors: Changhong Shi, Beijing (CN); Jin Wang, Beijing (CN); Zuwen Liu, Beijing (CN); Zihua Zhuang, Beijing (CN); Jiantao Lin, Beijing (CN); Jingguang Zhu, Beijing (CN); Zhendian Wu, Beijing (CN); Guichun Hong, Beijing (CN); Xinmao Qiu, Beijing (CN)

(21) Appl. No.: 16/893,602

(22) Filed: Jun. 5, 2020

(30) Foreign Application Priority Data
Dec. 19, 2019 (CN) 201911317578.9

(51) Int. Cl. B60R 1/08; B60R 1/12; G02F 1/157; G02F 1/155

(52) U.S. Cl. CPC B60R 1/088; B60R 1/12; B60R 2001/1223; G02F 1/155; G02F 1/157

(57) ABSTRACT

Embodiments of the present disclosure provide an anti-glare apparatus, a method for manufacturing the same, a rear-view mirror, an anti-glare method, a computer equipment, and a storage medium. The anti-glare apparatus includes: a first substrate; a second substrate; and a plurality of anti-glare cells. Each anti-glare cell includes a light intensity detector and an anti-glare display device. The light intensity detector is configured to detect a light intensity of incident light and output an electrical signal. The anti-glare display device is configured to adjust a light transmittance of the anti-glare display device according to the electrical signal output by the light intensity detector, so that outgoing light emitted after the incident light is reflected by the anti-glare display device has a light intensity that is within a preset light intensity range.

### CROSS-REFERENCE TO RELATED APPLICATION

This application claims priority of Chinese Patent Application No. 201911317578.9 filed on Dec. 19, 2019 in China National Intellectual Property Administration, the disclosure of which is incorporated herein by reference in entirety.

### TECHNICAL FIELD

Embodiments of the present disclosure relate to the field of display technology, and in particular, to an anti-glare apparatus and a method for manufacturing an anti-glare apparatus, a rear-view mirror, an anti-glare method, a computer equipment, and a storage medium.

### BACKGROUND

With the economic development, there are more and more vehicles running on the roads, and driving safety is also more and more concerned by people. At present, in the driving process, especially when driving at night, the reflection problem of the rear-view mirror becomes a major safety hazard. When strong light is illuminated on the rear-view mirror, it will directly affect the driver's vision through reflection into the driver's eyes. For the current manual anti-glare rear-view mirror, it needs to adjust the angle of the mirror surface by manually moving a small paddle, to change the angle of the reflected light to achieve the anti-glare effect, but it is not suitable for varied incident light.

### SUMMARY

According to a first embodiment of the present disclosure, there is provided an anti-glare apparatus, comprising:

a first substrate;

a second substrate opposite to the first substrate; and

a plurality of anti-glare cells between the first substrate and the second substrate,

wherein each of the plurality of anti-glare cells comprises a light intensity detector and an anti-glare display device,

wherein the light intensity detector is configured to detect a light intensity of incident light and output an electrical signal,

wherein the anti-glare display device is configured to adjust a light transmittance of the anti-glare display device according to the electrical signal output by the light intensity detector, so that outgoing light emitted after the incident light is reflected by the anti-glare display device has a light intensity that is within a preset light intensity range,

wherein the anti-glare display device comprises:
a reflective plate;
a first electrode;
a second electrode opposite to the first electrode;
an electrostrictive device between the first electrode and the second electrode; and
a transparent film between the first electrode and the second electrode,

wherein a light transmittance of the transparent film is adjustable,

wherein the electrostrictive device is configured to deform according to a voltage applied to the first electrode and the second electrode, to adjust a level of stretch of the transparent film so as to adjust the light transmittance of the transparent film, so that the incident light passes through the transparent film to reach the reflective plate, then is reflected, and then is emitted out through the transparent film.

According to some embodiments of the present disclosure, the transparent film comprises polydimethylsiloxane.

According to some embodiments of the present disclosure, the light intensity detector comprises a photoelectric sensor and a thin film transistor.

According to some embodiments of the present disclosure, the photoelectric sensor comprises a third electrode, a fourth electrode, and a photosensitive element between the third electrode and the fourth electrode, the photosensitive element is configured to sense the incident light and generate a current which is transmitted to a controller via the thin film transistor.

According to some embodiments of the present disclosure, the photosensitive element is a photodiode.

According to some embodiments of the present disclosure, each of the plurality of anti-glare cells comprises a first region and a second region adjacent to each other, the light intensity detector is formed in the first region, and the anti-glare display device is formed in the second region.

According to some embodiments of the present disclosure, the light intensity detector comprises a thin film transistor formed on the first substrate and a photoelectric sensor formed on the thin film transistor, the thin film transistor comprises an active layer, a gate electrode, a source electrode, and a drain electrode, the photoelectric sensor comprises a third electrode, a fourth electrode, and a photosensitive element between the third electrode and the fourth electrode, the third electrode is electrically connected to the drain electrode, and the source electrode is electrically connected to a controller.

According to some embodiments of the present disclosure, the plurality of anti-glare cells are arranged in an array.

According to some embodiments of the present disclosure, the anti-glare apparatus further comprises a controller which is configured to independently control each of the plurality of anti-glare cells.

According to a second embodiment of the present disclosure, there is provided a rear-view mirror, comprising the anti-glare apparatus according to any one of the above embodiments.

According to a third embodiment of the present disclosure, there is provided an anti-glare method using the anti-glare apparatus according to any one of the above embodiments, comprising:

obtaining a light intensity of the incident light according to the electrical signal output by the light intensity detector after sensing the incident light;

adjusting the light transmittance of the anti-glare display device according to the light intensity of the incident light, so that the outgoing light emitted after the incident light is reflected by the anti-glare display device has a light intensity that is within a preset light intensity range.

According to some embodiments of the present disclosure, the adjusting the light transmittance of the anti-glare display device according to the light intensity of the incident light further comprises:

adjusting the voltage applied to the first electrode and the second electrode according to the light intensity of the incident light, so that the electrostrictive device deforms according to the voltage applied to the first electrode and the second electrode, to adjust a level of stretch of the transparent film so as to adjust the light transmittance of the transparent film, such that the incident light passes through the transparent film and reaches the reflective plate, then is reflected, and then is emitted out through the transparent film.

According to some embodiments of the present disclosure, the light intensity detector comprises a photoelectric sensor and a thin film transistor, the photoelectric sensor comprises a third electrode, a fourth electrode, and a photosensitive element between the third electrode and the fourth electrode,

wherein the obtaining a light intensity of the incident light according to the electrical signal output by the light intensity detector after sensing the incident light further comprises:

sensing the incident light by the photosensitive element under the voltage applied to the third electrode and the fourth electrode and generating a current which is transmitted to a controller via the thin film transistor; and

obtaining the light intensity of the incident light by the controller according to the electrical signal received.

According to a fourth embodiment of the present disclosure, there is provided a method for manufacturing the anti-glare apparatus according to any one of the above embodiments, comprising:

forming a plurality of anti-glare cells on the first substrate, each of the plurality of anti-glare cells comprising a light intensity detector and an anti-glare display device;

forming the second substrate on the anti-glare cells;

forming a controller, the controller being electrically connected to the light intensity detector and the anti-glare display device.

According to some embodiments of the present disclosure, each of the plurality of anti-glare cells comprises a first region and a second region adjacent to each other,

wherein the forming a plurality of anti-glare cells on a first substrate further comprises:

forming a light intensity detector in the first region of the first substrate; and

forming an anti-glare display device in the second region of the first substrate.

According to some embodiments of the present disclosure, the forming a light intensity detector in the first region of the first substrate further comprises:

forming a thin film transistor in the first region of the first substrate, the thin film transistor comprising an active layer, a gate electrode, a source electrode and a drain electrode, the source electrode being electrically connected to the controller;

forming a photoelectric sensor on the thin film transistor, the photoelectric sensor comprising a third electrode, a fourth electrode, and a photosensitive element between the third electrode and the fourth electrode, the third electrode being electrically connected to the drain electrode,

wherein the forming an anti-glare display device in the second region of the first substrate further comprises:

forming a reflective plate in the second region of the first substrate;

forming a first electrode on the reflective plate;

forming an electrostrictive device and a transparent film controlled by the electrostrictive device on the first electrode; and

forming a second electrode on the electrostrictive device and the transparent film.

According to a fifth embodiment of the present disclosure, there is provided a computer-readable storage medium, in which a computer program is stored, wherein the anti-glare method according to any one of the above embodiments is implemented when the program is executed by a processor.

According to a sixth embodiment of the present disclosure, there is provided a computer equipment, comprising a memory, a processor, and a computer program stored in the memory and executable by the processor, wherein the anti-glare method according to any one of the above embodiments is implemented when the processor executes the program.

### BRIEF DESCRIPTION OF THE DRAWINGS

In order to more clearly describe the technical solutions in the embodiments of the present disclosure, the drawings used in the description of the embodiments will be briefly introduced below. Obviously, the drawings in the following description only refer to some embodiments of the present disclosure, and other drawings may be obtained by those skilled in the art based on these drawings without any creative efforts.

FIG. 1 is a schematic structural view of an anti-glare apparatus according to an embodiment of the present disclosure;

FIG. 2 is a schematic structural view of an anti-glare cell according to an embodiment of the present disclosure;

FIG. 3 is a schematic structural view of a photoelectric sensor according to an embodiment of the present disclosure;

FIG. 4 is a flowchart of an anti-glare method according to an embodiment of the present disclosure;

FIG. 5 is a flowchart of a method for manufacturing an anti-glare apparatus according to an embodiment of the present disclosure; and

FIG. 6 is a schematic structural view of a computer equipment according to an embodiment of the present disclosure.

### DETAILED DESCRIPTION OF EMBODIMENTS

In order to explain the present disclosure more clearly, the present disclosure will be further described below in conjunction with optional embodiments and drawings. Similar parts in the drawings are denoted by the same reference numerals. It should be understood by those skilled in the art that the content specifically described below is illustrative rather than restrictive, and therefore it should not be used to limit the scope of the present disclosure.

It should be noted that the expressions “on”, “formed on” and “disposed on” described in the present disclosure may mean that one layer is directly formed or disposed on another layer, or it may mean that one layer is indirectly formed or disposed on another layer, that is, there are other layers between the two layers. In the present disclosure, unless otherwise stated, the expression “located in the same layer” means that two layers, components, members, elements or parts can be formed by the same patterning process, and that these two layers, components, members, elements or parts are generally formed of the same material. In the present disclosure, unless otherwise stated, the expression “patterning process” generally includes the steps of coating photoresist, exposing, developing, etching, stripping photoresist, and so on. The expression “one-time patterning process” means a process of forming a patterned layer, component, member, and the like by using one mask.

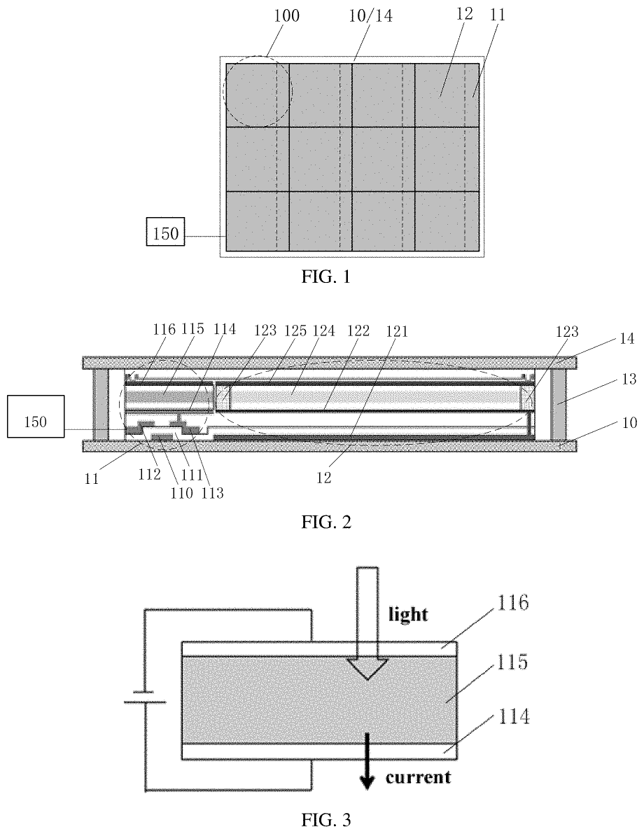

As shown in FIGS. 1 and 2, an embodiment of the present disclosure provides an anti-glare apparatus, including a controller 150, a first substrate 10, a second substrate 14, anti-glare cells 100 located between the first substrate 10 and the second substrate 14 and arranged in an array, each anti-glare cell includes a light intensity detector 11 and an anti-glare display device 12 which are juxtaposed; the controller 150 is configured to obtain a light intensity of incident light according to an electrical signal output by the light intensity detector 11 after sensing the incident light, and control a light transmittance of the anti-glare display device 12 according to the light intensity of the incident light, so that outgoing light emitted after the incident light is reflected by the anti-glare display device 12 has a light intensity that is within a preset light intensity range.

In this embodiment, the anti-glare apparatus is divided into multiple regions through the anti-glare cells arranged in an array. By means of the light intensity detector in each region, the light intensity of the light incident on the anti-glare cell is detected in real time, and according to the light intensity, the light transmittance of the corresponding anti-glare display device is adjusted, so as to adjust the light intensity of the outgoing light of the anti-glare apparatus, so that the light intensity of the outgoing light is within the preset light intensity range to achieve anti-glare function.

In other words, the anti-glare apparatus is divided into multiple regions, and each region is controlled independently, then in a smaller range for each region, the light intensity of the incident light therein may be sensed by the light intensity detector and the anti-glare display device in one-to-one correspondence, and the light intensity of the outgoing light in the range for this region is adjusted according to the light intensity of the incident light, thereby achieving accurate control of the outgoing light of the anti-glare apparatus, avoiding the problem of dazzling in some regions for the large-scale anti-glare apparatus due to the limited number of light intensity detectors. In the embodiment of FIG. 1, the anti-glare apparatus is divided into 4×3 anti-glare cells.

In an alternative embodiment, as shown in FIG. 2, the anti-glare display device 12 includes a reflective plate 121, a first electrode 122, a second electrode 125, an electrostrictive device 123 and a transparent film 124 located between the first electrode 122 and the second electrode 125, the transparent film 124 is controlled by the electrostrictive device 123 and has adjustable light transmittance. The electrostrictive device 123 is configured to deform according to a voltage applied to the first electrode 122 and the second electrode 125, to adjust a level of stretch of the transparent film 124 to obtain different light transmittances, so that the incident light is configured to pass through the transparent film 124 to reach the reflective plate 121, then to be reflected, and then to be emitted out through the transparent film 124. Here, the first electrode 122 and the second electrode 125 are transparent electrodes, which may be made of indium tin oxide (ITO) material, and the reflective plate 121 may be of a high-reflectivity metal layer.

In this embodiment, the anti-glare display device includes a reflective plate for reflecting incident light, and an electrostrictive device and a transparent film for adjusting light transmittance. First, the controller controls the deformation of the electrostrictive device by controlling the voltage of the first electrode and the second electrode applied to the electrostrictive device, thereby controlling the level of stretch of the transparent film stretched by the electrostrictive device, that is, different light transmittances may be obtained by changing the level of stretch of the transparent film. At the same time, the incident light incident on the anti-glare display device passes through the transparent film and reaches the reflective plate, then it is reflected, and then emitted out through the transparent film, that is, the light passes through the transparent film twice to reduce the light intensity, thereby avoiding the problem of dazzling the driver by a large light intensity of the outgoing light due to an excessively large light intensity of the incident light, which can effectively adjust the light intensity of the outgoing light and improve the driving safety of the driver.

In an alternative embodiment, the transparent film includes polydimethylsiloxane (PDMS).

In this embodiment, a rectangular transparent polydimethylsiloxane-stacked sheet is mixed with a solution containing black fine dye particles to form a transparent film. When the electrostrictive device is not applied with voltage, that is, the transparent film is in an unstretched state, the transparent film is in a fuzzy state, and the light is almost impenetrable; when the electrostrictive device is applied with voltage, the electrostrictive device deforms, the transparent film is stretched and deformed by the stretching of the electrostrictive device, then the transparent film gradually becomes transparent, and the light penetrates the transparent film. In this embodiment the characteristic of the transparent film to change the light transmittance according to the tensile deformation is used, and the light transmittance of the transparent film is adjusted by the voltage applied to both ends of the electrostrictive device which is used to control the level of stretch of the transparent film, thereby changing the light intensity of the outgoing light and achieving the anti-glare function of the anti-glare apparatus.

It should be noted that the above transparent film including polydimethylsiloxane is only a specific example for describing the technical solutions of the present disclosure. The material of the transparent film is not limited in the present disclosure, and all the transparent films that can achieve the adjustment of light transmittance are included within the scope of the present disclosure. At the same time, an appropriate transparent film may be selected by those skilled in the art according to the actual application situation, as long as a design criterion of adjustable light transmittance is met, therefore they will not be repeatedly described here.

In an alternative embodiment, as shown in FIGS. 2 and 3, the light intensity detector 11 includes a photoelectric sensor and a thin film transistor, wherein the photoelectric sensor includes a third electrode 114, a fourth electrode 116, and a photosensitive element 115 between the third electrode 114 and the fourth electrode 116. The photosensitive element 115 senses the incident light and generates a current, which is transmitted to the controller 150 via the thin film transistor.

In this embodiment, the light intensity of the light entering the anti-glare display device is sensed in real time by the photoelectric sensor, the photoelectric sensor includes a photoelectric sensing circuit formed by the photosensitive element 115, the third electrode 114 and the fourth electrode 116. The photosensitive element 115 senses the incident light under the voltage applied to the third electrode 114 and the fourth electrode 116, and the current generated by the photosensitive element sensing the incident light is transmitted to the thin film transistor through the photoelectric sensing circuit, and then transmitted to the controller 150 through the thin film transistor.

In an alternative embodiment, the photosensitive element is a photodiode.

In this embodiment, one end of the photodiode is connected to the third electrode 114 and the other end is connected to the fourth electrode 116, to form a photoelectric sensing circuit. When the incident light enters into the anti-glare cell, the photodiode senses the incident light and forms a current, the current is transmitted to the controller via the thin film transistor, so that the controller obtains the light intensity of the incident light according to the electrical signal output by the photoelectric sensor, so as to control the light transmittance of the anti-glare display device according to the light intensity.

It should be noted that the photodiode is only a specific example for describing the technical solutions of the present disclosure. The type of the photosensitive element is not limited in the present disclosure, and all the photosensitive elements capable of sensing the light intensity of incident light are included within the scope of the present disclosure. Therefore, an appropriate photosensitive element may be selected by those skilled in the art according to the actual application situation, as long as a design criterion that the light intensity of the incident light may be sensed is met, therefore they will not be repeatedly described here.

In a specific embodiment, as shown in FIG. 2, the anti-glare cell includes a first region and a second region adjacent to each other, corresponding to the first substrate. The anti-glare cell includes: a light intensity detector 11 formed in the first region of the first substrate; and an anti-glare display device 12 formed in the second region of the first substrate 10. The light intensity detector 11 includes a thin film transistor formed on the first substrate 10 and a photoelectric sensor formed on the thin film transistor. The thin film transistor includes a gate electrode 110, an active layer 111, a source electrode 112 and a drain electrode 113, and the photoelectric sensor includes a third electrode 114, a fourth electrode 116, and a photosensitive element 115 between the third electrode 114 and the fourth electrode 116. The third electrode 114 is electrically connected to the drain electrode 113, and the source electrode 112 is electrically connected to the controller 150. The anti-glare display device 12 includes a reflective plate 121 formed on the first substrate 10, and a first electrode 122 formed on the reflective plate 121, an electrostrictive device 123 and a transparent film 124 controlled by the electrostrictive device 123 formed on the first electrode 122, a second electrode 125 formed on the electrostrictive device 123 and the transparent film 124.

In a specific embodiment, a frame sealing device 13 is provided between the first substrate 10 and the second substrate 14, and the frame sealing device 13 seals the structure constituting the light intensity detector 11 and the structure constituting the anti-glare display device 12, between the first substrate 10 and the second substrate 14.

In this embodiment, an orthographic projection of the light intensity detector on the first substrate and an orthographic projection of the anti-glare display device on the first substrate do not overlap, that is, the anti-glare cell performs light intensity detection and light transmittance adjustment by means of the juxtaposed light intensity detector and anti-glare display device. The light intensity detector senses the light intensity of the incident light in real time, and at the same time the light transmission of the anti-glare display device is controlled according to the light intensity of the incident light, so that the light intensity of the outgoing light from the anti-glare display device is within the preset light intensity range, thereby addressing the problems in the prior art and effectively improving the safety performance during driving.

Corresponding to the anti-glare apparatus provided by the above embodiments, an embodiment of the present disclosure provides an anti-glare method using the above anti-glare apparatus. Since the anti-glare method provided by this embodiment of the present disclosure corresponds to the anti-glare apparatus provided by the above several embodiments, the details and effects described in the anti-glare apparatus according to the previous embodiments also apply to the anti-glare method provided in this embodiment, and therefore they will not be described in detail in this embodiment.

As shown in FIG. 4, an embodiment of the present disclosure further provides an anti-glare method using the above anti-glare apparatus, including: obtaining a light intensity of the incident light by a controller according to the electrical signal output by the light intensity detector sensing the incident light; controlling the light transmittance of the anti-glare display device by the controller according to the light intensity of the incident light, so that the light intensity of the outgoing light emitted after the incident light is reflected by the anti-glare display device is within a preset light intensity range.

In a specific example, the light intensity detector includes a photoelectric sensor and a thin film transistor, the photoelectric sensor includes a third electrode, a fourth electrode, and a photosensitive element between the third electrode and the fourth electrode; the anti-glare display device includes a reflective plate, a first electrode, a second electrode, an electrostrictive device and a transparent film with adjustable light transmittance between the first electrode and the second electrode. Specifically, the anti-glare method includes:

Firstly, sensing the incident light by the photosensitive element under the voltage applied to the third electrode and the fourth electrode and generating a current which is transmitted to a controller via the thin film transistor;

Secondly, obtaining the light intensity of the incident light by the controller according to the electrical signal received.

Finally, adjusting the voltage applied to the first electrode and the second electrode by the controller according to the light intensity of the incident light, so that the electrostrictive device deforms according to the voltage applied to the first electrode and the second electrode, to adjust a level of stretch of the transparent film to obtain different light transmittances, thereby the incident light passes through the transparent film and reaches the reflective plate, then is reflected, and then is emitted out through the transparent film.

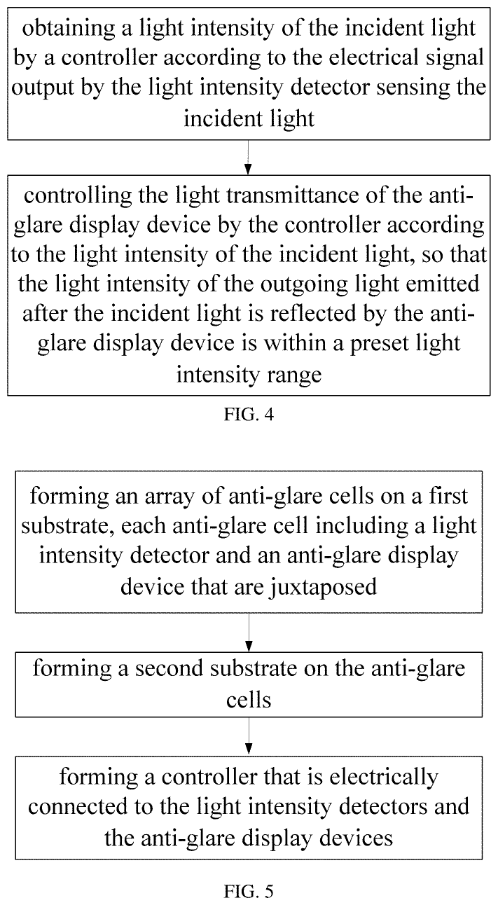

As shown in FIG. 5, an embodiment of the present application further provides a method for manufacturing the above anti-glare apparatus, including: forming an array of anti-glare cells on a first substrate, each anti-glare cell including a light intensity detector and an anti-glare display device that are juxtaposed; forming a second substrate on the anti-glare cells; forming a controller that is electrically connected to the light intensity detectors and the anti-glare display devices.

In a specific example, as shown in FIG. 2, each anti-glare cell includes a first region and a second region corresponding to the first substrate, and the manufacturing method specifically includes:

Firstly, forming the light intensity detector 11 in the first region of the first substrate 10.

Specifically, a thin film transistor is formed in the first region of the first substrate 10, the thin film transistor includes a gate electrode 110, an active layer 111, a source electrode 112, and a drain electrode 113, and the source electrode 112 is electrically connected to the controller.

A photoelectric sensor is formed on the thin film transistor, the photoelectric sensor includes a third electrode 114, a fourth electrode 116, and a photosensitive element 115 between the third electrode 114 and the fourth electrode 116, and the third electrode 114 is electrically connected to the drain electrode 113.

Next, forming the anti-glare display device 12 in the second region of the first substrate 10.

Specifically, a reflective plate 121 is formed in the second region of the first substrate 10, a first electrode 122 is formed on the reflective plate 121, an electrostrictive device 123 and a transparent film 124 controlled by the electrostrictive device 123 are formed on the first electrode 122, and a second electrode 125 is formed on the electrostrictive device 123 and the transparent film 124.

So far, the manufacture of the anti-glare apparatus is completed.

Based on the above anti-glare apparatus, an embodiment of the present application further provides a rear-view mirror, including the above anti-glare apparatus.

By means of the anti-glare apparatus, the rear-view mirror according to this embodiment senses the light intensity of the incident light in the region of each anti-glare cell in real time, and at the same time controls the light transmittance of the region of each anti-glare cell according to the light intensity of the incident light, so that the light intensity of the outgoing light emitted from the rear-view mirror is within the preset light intensity range, thereby avoiding the problem of dazzling the driver due to the incident strong light, and effectively avoiding the safety hazards during driving. Therefore, the present application has a wide application prospect.

An embodiment of the present disclosure provides a computer-readable storage medium in which a computer program is stored, when the program is executed by a processor, it implements: obtaining a light intensity of the incident light by a controller according to the electrical signal output by the light intensity detector sensing the incident light; controlling the light transmittance of the anti-glare display device by the controller according to the light intensity of the incident light, so that the light intensity of the outgoing light emitted after the incident light is reflected by the anti-glare display device is within a preset light intensity range.

In practical applications, the computer-readable storage medium may be a computer-readable medium or any combination of two or more computer-readable media. The computer-readable medium may be a computer-readable signal medium or a computer-readable storage medium. The computer-readable storage medium may be, for example but not limited to, an electrical, magnetic, optical, electromagnetic, infrared, or semiconductor system, apparatus or device, or any combination of the above. More specific examples of the computer-readable storage media (non-exhaustive list) include: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In this embodiment, the computer-readable storage medium may be any tangible medium that contains or stores a program, which may be used by or in combination with an instruction execution system, apparatus, or device.

The computer-readable signal medium may include a data signal that is propagated in baseband or as part of a carrier wave, in which computer-readable program codes are carried. This propagated data signal can take many forms, including but not limited to, an electromagnetic signal, an optical signal, or any suitable combination of the above. The computer-readable signal medium may also be any computer-readable medium other than a computer-readable storage medium, and the computer-readable medium may send, propagate, or transmit a program used by or in conjunction with an instruction execution system, apparatus, or device.

The program codes contained in the computer-readable medium may be transmitted by using any appropriate medium, including but not limited to, wireless, wire, optical cable, RF, etc., or any suitable combination of the above.

The computer program codes for performing the operations of the present disclosure may be written in one or more programming languages or a combination thereof. The programming languages include object-oriented programming languages such as Java, Smalltalk, C++, as well as conventional procedural programming languages such as “C” language or similar programming language. The program codes may be entirely executed on the user's computer, partly executed on the user's computer, executed as an independent software package, partly executed on the user's computer and partly executed on a remote computer, or entirely executed on a remote computer or server. In the situations involving a remote computer, the remote computer may be connected to the user's computer through any kind of network, including a local area network (LAN) or a wide area network (WAN), or may be connected to an external computer (for example, connected through an internet provided by an internet service provider).

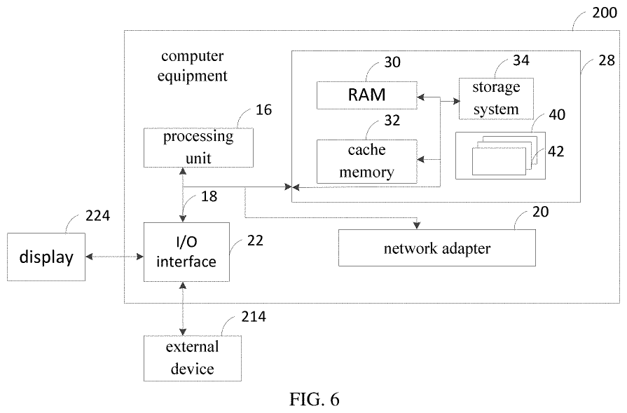

As shown in FIG. 6, a schematic structural view of a computer equipment according to an embodiment of the present disclosure is shown. The computer equipment 200 shown in FIG. 6 is only an example, and should not be construed as limiting the functions and application scopes of the embodiments of the present disclosure.

As shown in FIG. 6, the computer equipment 200 is represented in the form of a general-purpose computing equipment. The components of the computer equipment 200 may include, but not limited to, one or more processors or processing units 16, a system memory 28, and buses 18 connecting different system components (including the system memory 28 and the processing units 16).

The buses 18 may be one or more of several types of bus structures, including a memory bus or memory controller, a peripheral bus, a graphics acceleration port, a processor, or a local bus that uses any of a variety of bus structures. For example, these architectures include, but are not limited to, an industry standard architecture (ISA) bus, a micro channel architecture (MCA) bus, an enhanced ISA bus, a video electronics standards association (VESA) local bus, and a peripheral component interconnection (PCI) bus.

The computer equipment 200 typically includes a variety of computer system readable media. These media may be any available media that can be accessed by the computer equipment 200, including volatile and non-volatile media, removable and non-removable media.

The system memory 28 may include computer system readable media in the form of volatile memory, such as a random access memory (RAM) 30 and/or a cache memory 32. The computer equipment 200 may further include other removable/non-removable, volatile/nonvolatile computer system storage media. Merely by way of example, the storage system 34 may be used to read and write in non-removable, non-volatile magnetic media (commonly referred to as “hard drives”). Alternatively, a disk drive for reading and writing in a removable non-volatile magnetic disk (for example, a “floppy disk”), and an optical drive for reading and writing in a removable non-volatile optical disk (for example, a CD-ROM, a DVD-ROM, or any other optical media) may be provided. In these cases, each drive may be connected to the bus 18 via one or more data media interfaces. The memory 28 may include at least one program product having a set of (for example, at least one) program modules configured to perform the functions of various embodiments of the present disclosure.

A program/utility tool 40 having a set of (at least one) program modules 42 may be stored in, for example, the memory 28. Such program modules 42 include but are not limited to operating systems, one or more application programs, other program modules and program data. Each of these examples or some combination may include the implementation of a network environment. The program module 42 generally performs the functions and/or methods in the embodiments described in the present disclosure.

The computer equipment 200 may also communicate with one or more external devices 214 (for example, keyboard, pointing device, display 224, etc.), and may also communicate with one or more devices that enable a user to interact with the computer equipment 200, and/or communicate with any devices (for example, a network card, modem, etc.) that enable the computer equipment 200 to communicate with one or more other computing devices. This communication may be performed through an input/output (I/O) interface 22. Moreover, the computer equipment 200 may also communicate with one or more networks (for example, a local area network (LAN), a wide area network (WAN)), and/or a public network (for example, the Internet) through a network adapter 20. As shown in FIG. 6, the network adapter 20 communicates with other modules of the computer equipment 200 through the buses 18. It should be understood that other hardware and/or software modules may be used in conjunction with the computer equipment 200, they may include, but not limited to, microcode, device driver, redundancy processing unit, external magnetic disk drive array, RAID system, tape drive, data backup storage system and the like.

The processor unit 16 executes various functional applications and data processing by running programs stored in the system memory 28, for example, to implement the anti-glare method provided by the embodiments of the present disclosure.

In the embodiments of the present disclosure, the term “controller” may be implemented by one or more logical operation processing circuits, and the logical operation processing circuits may be represented as a processor, for example, they may be a Central Processing Unit (CPU), an Application Specific Integrated Circuit (ASIC), a Digital Signal Processor (DSP), a Field Programmable Gate Array (FPGA), a Single-chip Microcomputer (MCU), or the like.

In view of the existing problems, the embodiments of the present disclosure propose an anti-glare apparatus and a method for manufacturing the same, a rear-view mirror, an anti-glare method, a computer equipment, and a storage medium. The light intensity detectors of the anti-glare cells arranged in an array sense the light intensity of the incident light emitted to various anti-glare cells in real time, and at the same time the light transmittance of the anti-glare display devices are controlled according to the light intensity of the incident light, so that the light intensity of the outgoing light emitted from the anti-glare apparatus is within the preset light intensity range, thereby it addresses the problems in the prior art, effectively improves the safety performance during driving, and has wide application prospects.

Obviously, the above-mentioned embodiments of the present disclosure are only examples for clearly explaining the present disclosure, rather than limiting the embodiments of the present disclosure. Other different forms of changes or modifications may be made by those skilled in the art on the basis of the above-mentioned description, and it is not possible to exhaustively list all the implementations or embodiments. Any obvious changes or modifications derived from the technical solutions of the present disclosure fall within the scope of the present disclosure.

What is claimed is:

1. An anti-glare apparatus, comprising:
a first substrate;
a second substrate opposite to the first substrate; and
a plurality of anti-glare cells between the first substrate and the second substrate,
wherein each of the plurality of anti-glare cells comprises a light intensity detector and an anti-glare display device,
wherein the light intensity detector is configured to detect a light intensity of incident light and output an electrical signal,
wherein the anti-glare display device is configured to adjust a light transmittance of the anti-glare display device according to the electrical signal output by the light intensity detector, so that outgoing light emitted after the incident light is reflected by the anti-glare display device has a light intensity that is within a preset light intensity range,
wherein the anti-glare display device comprises:
a reflective plate;
a first electrode;
a second electrode opposite to the first electrode;
an electrostrictive device between the first electrode and the second electrode; and
a transparent film between the first electrode and the second electrode,
wherein a light transmittance of the transparent film is adjustable,
wherein the electrostrictive device is configured to deform according to a voltage applied to the first electrode and the second electrode, to adjust a level of stretch of the transparent film so as to adjust the light transmittance of the transparent film, so that the incident light passes through the transparent film to reach the reflective plate, then is reflected, and then is emitted out through the transparent film.

2. The anti-glare apparatus according to claim 1, wherein the transparent film comprises polydimethylsiloxane.

3. The anti-glare apparatus according to claim 1, wherein the light intensity detector comprises a photoelectric sensor and a thin film transistor.

4. The anti-glare apparatus according to claim 3, wherein the photoelectric sensor comprises a third electrode, a fourth electrode, and a photosensitive element between the third electrode and the fourth electrode, the photosensitive element is configured to sense the incident light and generate a current which is transmitted to a controller via the thin film transistor.

5. The anti-glare apparatus according to claim 4, wherein the photosensitive element is a photodiode.

6. The anti-glare apparatus according to claim 1, wherein each of the plurality of anti-glare cells comprises a first region and a second region adjacent to each other, the light intensity detector is formed in the first region, and the anti-glare display device is formed in the second region.

7. The anti-glare apparatus according to claim 6, wherein the light intensity detector comprises a thin film transistor formed on the first substrate and a photoelectric sensor formed on the thin film transistor, the thin film transistor comprises an active layer, a gate electrode, a source electrode, and a drain electrode, the photoelectric sensor comprises a third electrode, a fourth electrode, and a photosensitive element between the third electrode and the fourth electrode, the third electrode is electrically connected to the drain electrode, and the source electrode is electrically connected to a controller.

8. The anti-glare apparatus according to claim 1, wherein the plurality of anti-glare cells are arranged in an array.

9. The anti-glare apparatus according to claim 1, wherein the anti-glare apparatus further comprises a controller which is configured to independently control each of the plurality of anti-glare cells.

10. A rear-view mirror, comprising the anti-glare apparatus according to claim 1.

11. An anti-glare method using the anti-glare apparatus according to claim 1, comprising:
obtaining a light intensity of the incident light according to the electrical signal output by the light intensity detector after sensing the incident light;
adjusting the light transmittance of the anti-glare display device according to the light intensity of the incident light, so that the outgoing light emitted after the incident light is reflected by the anti-glare display device has a light intensity that is within a preset light intensity range.

12. The anti-glare method according to claim 11, wherein the adjusting the light transmittance of the anti-glare display device according to the light intensity of the incident light further comprises:
adjusting the voltage applied to the first electrode and the second electrode according to the light intensity of the incident light, so that the electrostrictive device deforms according to the voltage applied to the first electrode and the second electrode, to adjust a level of stretch of the transparent film so as to adjust the light transmittance of the transparent film, such that the incident light passes through the transparent film and reaches the reflective plate, then is reflected, and then is emitted out through the transparent film.

13. The anti-glare method according to claim 12, wherein the light intensity detector comprises a photoelectric sensor and a thin film transistor, the photoelectric sensor comprises a third electrode, a fourth electrode, and a photosensitive element between the third electrode and the fourth electrode,
wherein the obtaining a light intensity of the incident light according to the electrical signal output by the light intensity detector after sensing the incident light further comprises:
sensing the incident light by the photosensitive element under the voltage applied to the third electrode and the fourth electrode and generating a current which is transmitted to a controller via the thin film transistor; and
obtaining the light intensity of the incident light by the controller according to the electrical signal received.

14. A method for manufacturing the anti-glare apparatus according to claim 1, comprising:
forming a plurality of anti-glare cells on the first substrate, each of the plurality of anti-glare cells comprising a light intensity detector and an anti-glare display device;
forming the second substrate on the anti-glare cells;
forming a controller, the controller being electrically connected to the light intensity detector and the anti-glare display device.

15. The method according to claim 14, wherein each of the plurality of anti-glare cells comprises a first region and a second region adjacent to each other,
wherein the forming a plurality of anti-glare cells on a first substrate further comprises:
forming a light intensity detector in the first region of the first substrate; and
forming an anti-glare display device in the second region of the first substrate.

16. The method according to claim 15, wherein the forming a light intensity detector in the first region of the first substrate further comprises:
forming a thin film transistor in the first region of the first substrate, the thin film transistor comprising an active layer, a gate electrode, a source electrode and a drain electrode, the source electrode being electrically connected to the controller;
forming a photoelectric sensor on the thin film transistor, the photoelectric sensor comprising a third electrode, a fourth electrode, and a photosensitive element between the third electrode and the fourth electrode, the third electrode being electrically connected to the drain electrode,
wherein the forming an anti-glare display device in the second region of the first substrate further comprises:
forming a reflective plate in the second region of the first substrate;
forming a first electrode on the reflective plate;
forming an electrostrictive device and a transparent film controlled by the electrostrictive device on the first electrode; and
forming a second electrode on the electrostrictive device and the transparent film.

17. A computer-readable storage medium, in which a computer program is stored, wherein the anti-glare method according to claim 11 is implemented when the program is executed by a processor.

18. A computer equipment, comprising a memory, a processor, and a computer program stored in the memory and executable by the processor, wherein the anti-glare method according to claim 11 is implemented when the processor executes the program.
